(19) United States
(12) Patent Application Publication
(10) Pub. No.: US 2006/0086647 A1
(43) Pub. Date: Apr. 27, 2006

(54) Sorting method for winding remnants and winding tube

(75) Inventor: Dieter Quick, Lindlar (DE)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Kunststoff-Spritzgusswerk Ing. Klaus Burk GmbH

(21) Appl. No.: 11/292,777

(22) Filed: Dec. 2, 2005

Related U.S. Application Data
(63) Continuation of application No. PCT/EP04/05698, filed on May 27, 2004.

(30) Foreign Application Priority Data
Jun. 4, 2003 (DE) 103 25 511.7

(51) Int. Cl. B07C 5/344

(52) U.S. Cl. 209/571

(57) ABSTRACT

A sorting method is defined for remnants of a web-shaped semi-finished product wound on to plastic winding tubes. The winding tubes are detected and sorted out from the remnants of the web product in order to prepare the remnants for recycling. The web remnants and tubes are run through a detector in a continuous flow and the tubes are detected in an electromagnetic alternating field by the detector. An electrically conductive component is added to the tube.

### RELATED APPLICATION

This is a continuation of International Application No. PCT/EP2004/005698 filed May 27, 2004. This international application is herein incorporated by reference.

### BACKGROUND OF THE INVENTION

The invention relates to a sorting method for winding remnants of a web-shaped semi-finished product. The winding tubes for the remnants consist substantially of a plastic, cylindrical, elongated tubular body onto which the semi-finished product is wound. The remnants on the winding tube often need to be detected and sorted in order to finish processing.

Web-shaped semi-finished products with web widths of up to several meters are generally known in many forms within the framework-of industrial manufacturing processes and are often made available for processing in windings with diameters of up to several meters. Substantially flexible semi-finished products are wound onto winding tubes that impart the required stability for the winding procedure. Stability is especially of concern at the start of the web winding and also toward the end of the winding off. For example, paper for the industrial printing of newspapers and books, cellulose webs for manufacturing hygienic cloths and cleaning cloths, as well as the endless plurality of foils or sheets, textile fabrics and knit fabrics are made available for further processing as web-shaped semi-finished products on such winding tubes.

Semi-finished web products are frequently wound off of the tube in industrial manufacturing processes at speeds of up to several meters per second. Normal winding operation results in an increase in speed as the diameter decreases. Such speeds can result, especially in combination with the decrease in bending resistance of the winding, in distortion of the winding along the winding axis, due to, e.g., oscillations, and may cause tears in the web product. Also, bends or breaks in the winding tube may also occur.

In the described instances, in order to reduce operator risk and to increase product quality, the web product is generally not completely wound off of the winding tube, but rather remains as a remnant with a length of up to several hundred meters. The winding tube with the web remnant is returned into the manufacturing process for recycling.

A remnant of a PE foil web on a winding tube is, for example, torn to pieces, shredded and ground in several steps. Thereafter, the material is melted down again into granulate form and drawn again as a foil. The winding tube is generally removed prior to the preparation of the web product and reused for a new winding. The tube consists substantially or even entirely of plastic material and is not electrically conductive. The term “substantially of plastic material” is intended to denote in the sense of the present application in particular tubes that can also comprise very small amounts of cardboard and/or paper in addition to plastic but do not have any appreciable metallic components.

The winding tube can be damaged because of the high load during the tensioning process (that is, before the actual winding process) so that fragments of winding tubes, or even entire winding tubes, can be hidden between the remnants of the web product. If the winding tube is not detected in the remnants of the web product and is not sorted out before recycling, significant damage can result to the machines used and a loss of quality in the recycled product may occur.

In some applications, the ends of the winding tube are extremely stressed during the winding on and off of the web product. As a result, some tubes are built with adapters attached to their ends. The tube bodies are typically manufactured from cardboard, paper or an economical plastic in order to reduce expenses. The adapters are typically manufactured from higher quality and correspondingly more expensive plastics, with better properties of strength and wear resistance. In order to make multiple use of a high-quality adapter possible, they have been reinforced with radially running spokes. U.S. Pat. No. 3,547,367 suggests that such a tube adaptor can be disassembled from the tube body without being destroyed.

The experience in handling such adapters, that can be disassembled without being destroyed, shows that they occasionally come loose in an unintended manner when the winding is replaced and end up unnoticed between folds and rejects of the remnant of the web product. In addition, such adapters or their fragments can be hidden in the remnants.

These winding tube portions, including any adapters, have to be separated and sorted prior to the recycling of web remnants. In view of the differences of dimension (the length of the winding tubes and width of the web may be several meters, as opposed to dimension of a few decimeters for the adapters and millimeters for their fragments), this sorting may be expensive and is often subject to errors.

DE 34 23 866 A1 and DE 38 41 678 A1 teach equipment for separating out metallic particles and non-magnetizable, electrically conductive metallic parts from a mixture of solids that can consist of powdery, granular or lumpy goods. In both instances, the electrical conductivity of the parts to be detected and separated out is used. DE 38 41 678 A1 teaches a slide or slider that is controlled as a function of signals of a metal detector in such a manner that if the metal detector recognizes a metallic particle the slide separates a part of the conveyed goods through a separation opening. DE 34 23 866 A1 teaches the use of vortex currents that are induced in the NE metallic parts with the aid of an electromagnetic alternating field that make it possible to separate the magnetized parts out of a conveyed stream. In the case of winding tubes that consist substantially of plastic, and therefore do not have electrically conductive components, such detection and separating methods cannot be carried out without further additional measures.

### SUMMARY OF THE INVENTION

The present invention solves the problem of separating web remnants from tube and adapter parts in a continuous flow. The winding tube and/or adapter parts are detected in an electromagnetic alternating field applied when running through a detector. The web remnants are preferably roughly comminuted or removed from the tube before passing through the detector in order to achieve a continuous flow. A signal is generated by an electrically conductive component added to the winding tube and/or adapter parts. Thus, by the addition of this conductive component, the detector makes it possible to automatically sort known structural elements from the web remnants.

In a sorting method in accordance with the invention, the flow of the remnants is advantageously divided into segments as a result of the detection of the tube and/or adapters. Each flow segment is marked and automatically deflected into a waste flow branching off from the remnant flow. Segmenting of the flow of web remnants from other portions can be accomplished by walls arranged transversely to the direction of flow, as well as virtually by a representation of the flow in the control equipment. The detection process advantageously simplifies the representation of the various segments in digital control equipment. The segment loaded with winding tube can be conducted out of the flow of winding remnants at a later time using an applied marking. Such a marking can again take place in a concrete manner, e.g. in the form of a colored marking, or virtually in a data record associated with the segment in the control equipment.

Using such a marking, a segment loaded with winding tube remnants can be conducted automatically or manually out of the flow of winding remnant into a waste flow. This waste flow can be conducted, e.g., to an intensive visual monitoring, or, after a detailed segmentation, once again in a detector. In this manner, the manual expense of the sorting method of the invention is minimized and its error rate is reduced.

A winding tube on which a web product is to be wound is typically made of a plastic material. A metallic foil may be provided extending in a circumferential direction along at least a portion of the tube body. The weight component of the metallic foil in the total weight of the winding tube is below 5%, preferably below 2% and in long tubes even below 1%. The goal of the conscious addition of metal to the winding tube is to reliably ensure detectability. However, it is advantageous to keep the metallic component as low as possible. The metallic foil, preferably copper or aluminum, does not influence the mechanical properties of a winding tube. However, even a small piece of metallic foil, moved in an electromagnetic alternating field applied to a flow of winding remnants, generates a distinctly detectable signal. In this manner, even small fragments of a winding tube in accordance with the invention can be detected.

The winding tube may be coated with a metallic foil. Alternatively, the tube may be applied with axially screwed-in metallic bodies, such as screws, in the tube surface. The screws can be removed from the winding tube as needed without great expense. In addition, the screws may also serve to protect the surface of the tube for mechanical stress during removal of the web product, since the screw heads may be arranged so to project out of the outside surface of the tube.

In addition, the plastic winding tube may comprise electrically conductive particles, at least in some areas of the winding tube. In such a winding tube, even extremely small fragments can be detected, as in the design with a metallic foil and to an even greater extent. On the other hand, this winding tube is well suited for recycling since it consists of a unified material, assuming a uniform distribution of the particles in the areas concerned. It is preferable that such a winding tube in accordance with the invention be compounded with soot [black]. Soot particles are economical and can be distributed readily in a plastic material by the mixing and extrusion process of the injection molding operation. Metallic particles, e.g., copper dust or aluminum dust, can also be mixed into the to be extruded plastic.

A winding tube in accordance with the invention can in particular also comprise a cylindrical adapter on one or both ends that can be attached to the tube body and can be removed from the tube body without being destroyed. Depending on the particular requirements, the metallic foil, the screwed-in metallic bodies or the electrically conductive particles can be attached to the tube body, the adapter or both.

The foil can be adhesively applied to a surface on the adapter, preferably on an inner surface. The foil is advantageously exposed to fewer mechanical stresses on an inner surface in comparison to being arranged on an outer surface, since the adapter is inserted into the end of the tube body and makes contact with the tube inner surface. In an adapter, the foil may be arranged in a pocket that is set below the surface of the adapter. In this manner, the mechanical stressing of the foil can be reduced even for the instance where mechanical structures are inserted into the adapter.

### BRIEF DESCRIPTION OF DRAWINGS

The invention is explained in the following using exemplary embodiments.

FIG. 1a shows a first adapter in accordance with the invention in a front view.

FIG. 1b shows the first adapter in a longitudinal section.

FIG. 2a shows a second adapter in accordance with the invention in a front view.

FIG. 2b shows the second adapter in a longitudinal section.

FIG. 3a shows a third adapter in accordance with the invention in a front view.

FIG. 3b shows the third adapter in a longitudinal section.

### DETAILED DESCRIPTION OF THE DRAWINGS

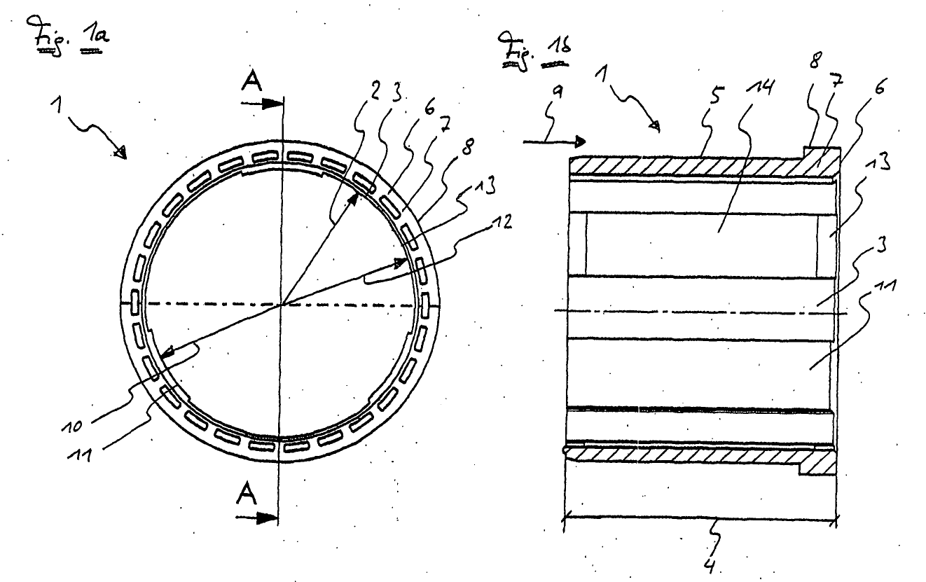

FIG. 1a shows an adapter 1 in accordance with the invention having a thermoplastic plastic winding tube on which a web-shaped semi-finished product can be received. The winding tube comprises a cylindrical, elongated tube body in which adapter 1 can be positioned on an end. The winding tube, the web-shaped semi-finished product and the tube body are not shown. FIG. 1b shows a section through adapter 1 along section line designated by “A-A” in FIG. 1a.

Adapter 1 is designed like a tube and radius 2 of its cylindrical inner jacket surface 3 corresponds approximately to one-half its axial length 4. Adapter 1 comprises outer jacket surface 5 that is also cylindrical. A radially outwardly projecting shoulder 7 is formed on front side 6 of adapter 1. Outer jacket surface 8, also cylindrical, of this shoulder 7 is flush with the winding surface of the tube body.

Inner jacket surface 3 of adapter 1 has a constant profile in axial direction 9 of adapter 1. Adapter 1 is provided with three springs 11 projecting out of its inner jacket surface 3 on a smaller radius 10 that engage in corresponding grooves of a drive bolt (also not shown) and thus make possible an exact positioning of the winding and on the other hand a slip-free drive.

Adapter 1 comprises three pockets 13 that are set below its inner jacket surface 3. A section of a metallic foil 14 is adhered within pockets 13 in inner jacket surface 3 of adapter 1.

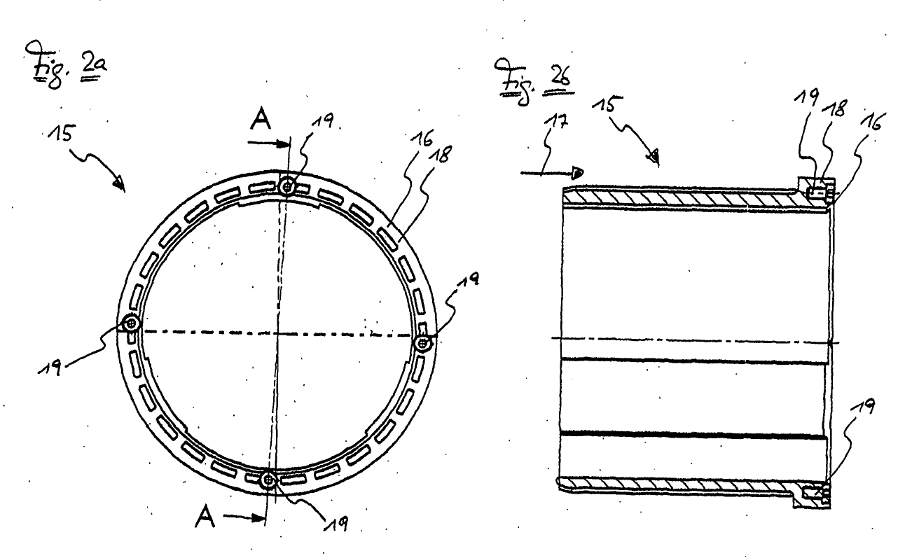

FIG. 2a shows a second adapter 15 in accordance with the invention that corresponds in its basic design to adapter 1 shown in FIGS. 1a, 1b. FIG. 2b shows a section through adapter 15 along section line designated in FIG. 2a by “A-A”. Adapter 15 comprises four metallic screws 19 on its front side 16 that are screwed into collar 18 in its axial direction 17.

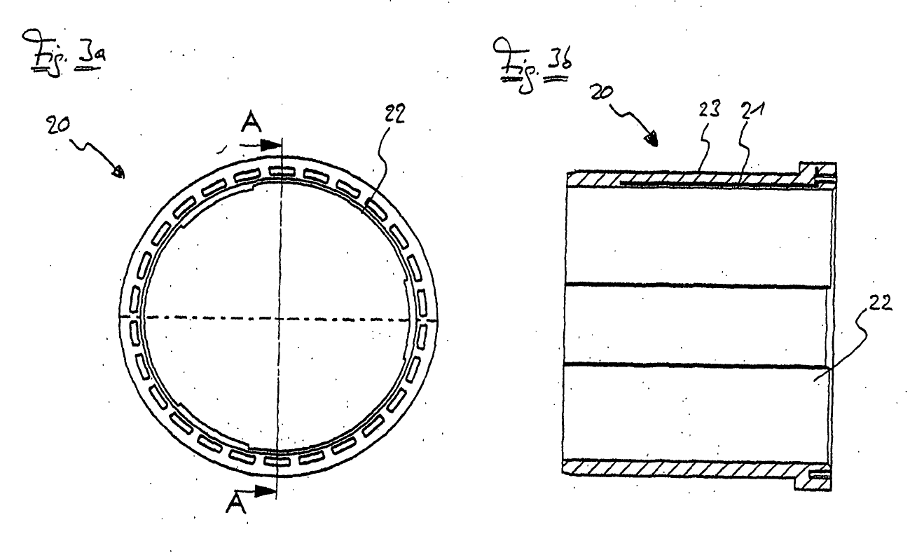

FIG. 3a shows a third adapter 20 in accordance with the invention that again corresponds in its basic design to adapters 1 and 15 shown in FIGS. 1a, 1b, 2a and 2b. FIG. 3b shows a section through adapter 20 along the section line designated by “A-A” in FIG. 3a. This adapter 20 comprises a section of a metallic foil 21 that is arranged between its inner jacket surface 22 and its outer jacket surface 23 and around which the plastic material of adapter 20 is extruded, sprayed or injection molded

1. A sorting method for winding remnants comprising remnants of a web product and a elongated, cylindrical winding tube that consist substantially of a plastic material and onto which the web product is wound, the method comprising the steps of:
passing the winding remnants through a detector in a continuous flow, and
detecting the remnants of the winding tubes in an electromagnetic alternating field when running through the detector by means of their influence deviating from the influence of the web product, which influence is produced by an electrically conductive component added to the winding tube.

2. The sorting method in accordance with claim 1, further comprising the steps of:
marking the segment detected by the detector as a waste flow,
dividing the flow of the winding remnants into segments, and
deflecting into a waste flow off from the main flow of the winding remnants.

3. A winding tube on which a web-shaped semi-finished product can be received, the tube comprising:
a cylindrical, elongated tube body, the tube body made of a plastic material, and
a metallic foil extending in a circumferential direction around at least a portion of the tube body.

4. The winding tube according to claim 3, wherein the metallic foil is provided on a front side of the tube body and a plurality of axially screwed-in metallic bodies are provided on the tube.

5. The winding tube according to claim 3, wherein the plastic of the tube body includes electrically conductive particles throughout at least a portion of the tube body.

6. The winding tube according to claim 5, characterized in that the plastic is compounded with soot black.

7. The winding tube according to claim 3, further comprising at least one cylindrical adapter attached to the tube body on one end, and the adaptor being removable from the tube body without being destroyed.

8. The winding tube according to claim 7, wherein the adapter is designed as a tube and a metallic foil is arranged at least in sections on an inner jacket surface of the adapter.

9. The winding tube according to claim 7, wherein the foil is arranged in at least one pocket that is positioned radially inward of the surface of the adapter.

10. The winding tube according to claim 7, wherein the adaptor consists substantially of a plastic material.
